(19) United States
(12) Patent Application Publication
(10) Pub. No.: US 2022/0358614 A1
(43) Pub. Date: Nov. 10, 2022

(54) MOBILITY SERVICE SYSTEM AND MOBILITY SERVICE DELIVERY METHOD

(71) Applicant: TOYOTA JIDOSHA KABUSHIKI KAISHA, Toyota-shi (JP)

(72) Inventor: Narihito YAMAZATO, Tokyo-to (JP)

(73) Assignee: TOYOTA JIDOSHA KABUSHIKI KAISHA, Toyota-shi (JP)

(21) Appl. No.: 17/727,926

(22) Filed: Apr. 25, 2022

(30) Foreign Application Priority Data
May 10, 2021 (JP) 2021-079656

(51) Int. Cl. G06Q 50/30; G06Q 10/02

(52) U.S. Cl. CPC G06Q 50/30; G06Q 10/02

(57) ABSTRACT

A mobility service system delivers a mobility service utilizing a vehicle. Reservation information indicates a reservation that picks up a user of the mobility service at a first pick-up point at a reservation time. The mobility service system calculates, based on user status information indicating a position and a moving speed of the user, a first expected arrival time at which the user arrives at the first pick-up point. When the first expected arrival time is later than the reservation time, the mobility service system executes an operation pattern adjustment process that adjusts an operation pattern of an assigned vehicle for picking up the user. The operation pattern adjustment process is executed such that a waiting time from when the assigned vehicle arrives at a target pick-up point for picking up the user to when the user arrives at the target pick-up point is reduced.

### CROSS-REFERENCE TO RELATED APPLICATION

This application claims priority to Japanese Patent Application No. 2021-079656 filed on May 10, 2021, the entire contents of which are incorporated by reference herein.

### BACKGROUND

### Technical Field

The present disclosure relates to a technique of delivering a mobility service utilizing a vehicle.

### Background Art

Patent Literature 1 discloses a vehicle reservation system used in car sharing. A user is able to make a reservation of a vehicle by accessing a reservation center from a mobile information terminal. The mobile information terminal transmits a location information to the reservation center a predetermined time before a rental start time. Based on the location information transmitted from the mobile information terminal, the reservation center determines whether the user is able to arrive at a rental place by the rental start time. When it is determined that the user is not able to arrive, the reservation center transmits a proposal for a reservation change to the mobile information terminal.

### List of Related Art

Patent Literature 1: Japanese Laid-Open Patent Application Publication No. JP-2011-258069

### SUMMARY

A mobility service utilizing a vehicle is considered. A user specifies a desired pick-up point and a desired pick-up time to make a reservation for the mobility service. A vehicle assigned to the user arrives and stops at the pick-up point by the reservation time. Here, if the user is late for the reservation time, the vehicle needs to continue to wait (stop) at the pick-up point. Stopping for a long time disturbs a surrounding traffic flow.

In the Patent Literature 1 related to the car sharing, the waiting time of the vehicle and the influence on the surrounding traffic flow are not considered.

An object of the present disclosure is to provide a technique that can suppress an influence of a vehicle that stops for picking up a user on a surrounding traffic flow, in a mobility service utilizing a vehicle.

A first aspect is directed to a mobility service system that delivers a mobility service utilizing a vehicle.

The mobility service system includes:
one or more processors; and
an operation pattern database indicating an operation pattern of the vehicle.

The one or more processors acquire reservation information indicating a reservation that picks up a user of the mobility service at a first pick-up point at a reservation time.

The one or more processors acquire user status information indicating at least a position and a moving speed of the user.

The one or more processors calculate, based on the user status information, a first expected arrival time at which the user arrives at the first pick-up point.

When the first expected arrival time is later than the reservation time, the one or more processors execute an operation pattern adjustment process that adjusts, based on the operation pattern database, the operation pattern of an assigned vehicle for picking up the user.

A waiting time is a time from when the assigned vehicle arrives at a target pick-up point for picking up the user to when the user arrives at the target pick-up point.

The one or more processors execute the operation pattern adjustment process such that the waiting time is reduced as compared with a case where the operation pattern adjustment process is not executed.

A second aspect is directed to a mobility service delivery method that delivers a mobility service utilizing a vehicle.

The mobility service delivery method includes:
managing an operation pattern database indicating an operation pattern of the vehicle;
acquiring reservation information indicating a reservation that picks up a user of the mobility service at a first pick-up point at a reservation time;
acquiring user status information indicating at least a position and a moving speed of the user;
calculating, based on the user status information, a first expected arrival time at which the user arrives at the first pick-up point; and
when the first expected arrival time is later than the reservation time, executing an operation pattern adjustment process that adjusts, based on the operation pattern database, the operation pattern of an assigned vehicle for picking up the user.

A waiting time is a time from when the assigned vehicle arrives at a target pick-up point for picking up the user to when the user arrives at the target pick-up point.

The operation pattern adjustment process is executed such that the waiting time is reduced as compared with a case where the operation pattern adjustment process is not executed.

According to the present disclosure, the first expected arrival time at which the user arrives at the first pick-up point is calculated based on the user status information. When the first expected arrival time is later than the reservation time, the operation pattern adjustment process is executed. The operation pattern adjustment process is executed such that the waiting time is reduced as compared with the case where the operation pattern adjustment process is not executed. Since the waiting time is reduced, the influence of the assigned vehicle that picks up the user on the surrounding traffic flow is suppressed.

### BRIEF DESCRIPTION OF DRAWINGS

FIG. 1 is a conceptual diagram for explaining an outline of a mobility service system according to an embodiment of the present disclosure;

FIG. 2 is a conceptual diagram for explaining an outline of an operation pattern adjustment process according to an embodiment of the present disclosure;

FIG. 3 is a conceptual diagram for explaining an example of an operation pattern adjustment process according to an embodiment of the present disclosure;

FIG. 4 is a conceptual diagram for explaining another example of an operation pattern adjustment process according to an embodiment of the present disclosure;

FIG. 5 is a conceptual diagram for explaining yet another example of an operation pattern adjustment process according to an embodiment of the present disclosure;

FIG. 6 is a block diagram showing a configuration example of a vehicle according to an embodiment of the present disclosure;

FIG. 7 is a block diagram showing a configuration example of a mobility service management system according to an embodiment of the present disclosure;

FIG. 8 is a conceptual diagram showing an example of an operation pattern database according to an embodiment of the present disclosure;

FIG. 9 is a flow chart showing a reservation acceptance process according to an embodiment of the present disclosure;

FIG. 10 is a flow chart showing processing related to an operation pattern adjustment process according to an embodiment of the present disclosure;

FIG. 11 is a flow chart showing a first example of an operation pattern adjustment process according to an embodiment of the present disclosure;

FIG. 12 is a flow chart showing a second example of an operation pattern adjustment process according to an embodiment of the present disclosure;

FIG. 13 is a flow chart showing a third example of an operation pattern adjustment process according to an embodiment of the present disclosure;

FIG. 14 is a flow chart showing a fourth example of an operation pattern adjustment process according to an embodiment of the present disclosure; and

FIG. 15 is a flow chart showing a fifth example of an operation pattern adjustment process according to an embodiment of the present disclosure.

### EMBODIMENTS

Embodiments of the present disclosure will be described with reference to the accompanying drawings.

### 1. OUTLINE OF MOBILITY SERVICE SYSTEM

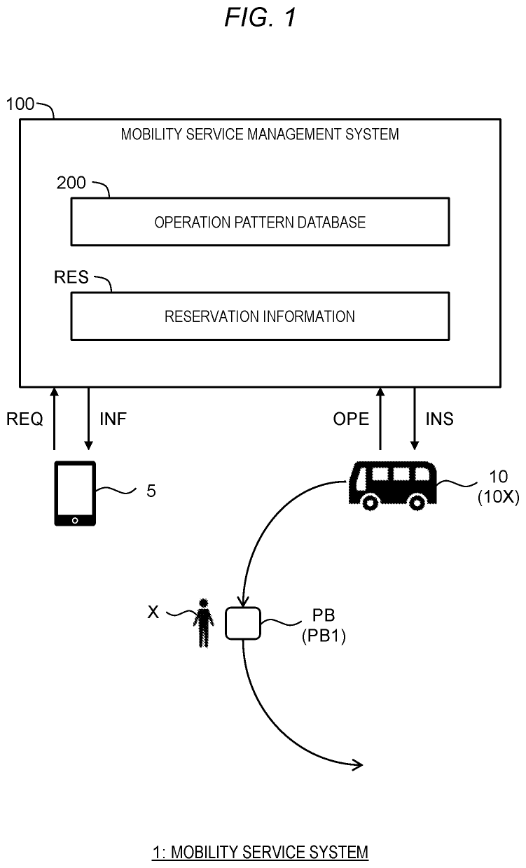

FIG. 1 is a conceptual diagram for explaining an outline of a mobility service system 1 according to the present embodiment. The mobility service system 1 delivers a mobility service to a user by utilizing a vehicle 10. The vehicle 10 may also be referred to as a MaaS (Mobility as a Service) vehicle. The vehicle 10 runs with the user. For example, the vehicle 10 is an automated driving vehicle that travels autonomously. As another example, the vehicle 10 is a vehicle driven by a driver. Typically, a plurality of vehicles 10 are utilized in one service area.

The user of the mobility service specifies at least a desired pick-up point PB and a desired pick-up time. The vehicle 10 assigned to the user goes to the pick-up point PB and picks up the user at the pick-up point PB. Then, the vehicle 10 goes to a drop-off point (i.e., a destination) desired by the user and drops off the user at the drop-off point.

A mobility service management system 100 manages such the mobility service. The mobility service management system 100 is constituted by one or more management servers. The mobility service management system 100 may be a distributed system. The management of the mobility service includes acceptance of a reservation for the mobility service, generation and management of an operation pattern of the vehicle 10, monitoring of an operation status of the vehicle 10, and the like. The management of the mobility service may include management of the users, delivery of information to the users, and the like.

An “operation pattern” of the vehicle 10 includes a pick-up point PB to pick up the user, a target arrival time to arrive at the pick-up point PB, a target departure time to depart from the pick-up point PB, and the like. The operation pattern of the vehicle 10 may include a drop-off point (i.e., a destination) to drop off the user, a target arrival time to arrive at the drop-off point, and the like. The operation pattern may further include a travel route of the vehicle 10. The operation pattern may further include a travel pattern (e.g., a target speed, and the like) of the vehicle 10.

The mobility service management system 100 includes an “operation pattern database 200” that indicates the operation pattern for each vehicle 10. The mobility service management system 100 manages the operation pattern database 200.

In addition, the mobility service management system 100 is able to communicate with each vehicle 10. For example, the mobility service management system 100 transmits an “operation pattern instruction INS” to the vehicle 10. The operation pattern instruction INS includes the operation pattern of the vehicle 10 and instructs the vehicle 10 to run in accordance with the operation pattern. On the other hand, the vehicle 10 transmits operation status information OPE indicating its own operation status to the mobility service management system 100. The operation status information OPE includes a current position, a vehicle speed, and the like of the vehicle 10. The mobility service management system 100 can monitor the operation status of each vehicle 10 based on the operation status information OPE.

Furthermore, the mobility service management system 100 is capable of communicating with a user terminal 5 operated by the user of the mobility service. Examples of the user terminal 5 include a smartphone, a PC, and the like. The mobility service management system 100 can deliver various kinds of service information INF to the user terminal 5.

A basic flow when a certain user X utilizes the mobility service is as follows.

The user X operates the user terminal 5 to specify a desired pick-up point PB and a desired pick-up time. The user X may further specify a desired drop-off point (destination). The user terminal 5 transmits a “reservation request REQ” including the information specified by the user X to the mobility service management system 100.

The mobility service management system 100 receives the reservation request REQ from the user terminal 5. In response to the reservation request REQ, the mobility service management system 100 selects (assigns) a vehicle 10 that delivers the mobility service to the user X. The operation pattern of each vehicle 10 can be obtained from the operation pattern database 200 described above. By referring to the operation pattern database 200, the mobility service management system 100 selects a vehicle 10 that is able to meet the user X's requirement specified by the reservation request REQ.

When the reservation is determined, the mobility service management system 100 acquires “reservation information RES” indicating the determined reservation. For convenience sake, the pick-up point PB reserved by the user X is hereinafter referred to as a “first pick-up point PB1.” The pick-up time reserved by the user X is hereinafter referred to as a “reservation time tx0.” The vehicle 10 assigned to the user X, that is, the vehicle 10 for picking up the user X is hereinafter referred to as an “assigned vehicle 10X.” The reservation information RES indicates the reservation that “the assigned vehicle 10X picks up the user X at the first pick-up point PB1 at the reservation time tx0.” The mobility service management system 100 delivers the service information INF including the reservation information RES to the user terminal 5.

In addition, the mobility service management system 100 generates or updates the operation pattern of the assigned vehicle 10X. For example, the mobility service management system 100 generates or updates the operation pattern of the assigned vehicle 10X such that the assigned vehicle 10X arrives at the first pick-up point PB1 immediately before the reservation time tx0. Then, the mobility service management system 100 updates the operation pattern database 200 by reflecting the latest operation pattern of the assigned vehicle 10X in the operation pattern database 200.

Furthermore, the mobility service management system 100 communicates with the assigned vehicle 10X to transmit the operation pattern instruction INS to the assigned vehicle 10X. The operation pattern instruction INS includes the operation pattern of the assigned vehicle 10X, and instructs the assigned vehicle 10X to run in accordance with the operation pattern.

The assigned vehicle 10X receives the operation pattern instruction INS from the mobility service management system 100. Then, the assigned vehicle 10X runs in accordance with the operation pattern included in the operation pattern instruction INS. For example, in a case where the assigned vehicle 10X is an automated driving vehicle, the assigned vehicle 10X performs automated driving control so as to travel in accordance with the operation pattern. As another example, in a case of manual driving, the assigned vehicle 10X presents the operation pattern to a driver. The driver drives the assigned vehicle 10X so as to travel in accordance with the operation pattern. The assigned vehicle 10X transmits the operation status information OPE to the mobility service management system 100. The mobility service management system 100 monitors the operation status of the assigned vehicle 10X based on the operation status information OPE.

The assigned vehicle 10X goes to the first pick-up point PB1, arrives and stops at the first pick-up point PB1 before the reservation time tx0, in accordance with the operation pattern. At the first pick-up point PB1, the user X gets on the assigned vehicle 10X. After that, the assigned vehicle 10X goes to the drop-off point (i.e., the destination) desired by the user X in accordance with the operation pattern.

### 2. OPERATION PATTERN ADJUSTMENT PROCESS

Next, we consider a case where the user X is late for the reservation time tx0, that is, a case where the user X does not appear at the first pick-up point PB1 at the reservation time tx0. If nothing is done with respect to the user X's lateness, the assigned vehicle 10X needs to continue to stop at the first pick-up point PB1 to wait for arrival of the user X. However, stopping for a long time disturbs a surrounding traffic flow, which is not desirable.

In view of the above, according to the present embodiment, when the lateness of the user X is expected, an adjustment of the operation pattern of the assigned vehicle 10X is appropriately made. Such the process is hereinafter referred to as an “operation pattern adjustment process.”

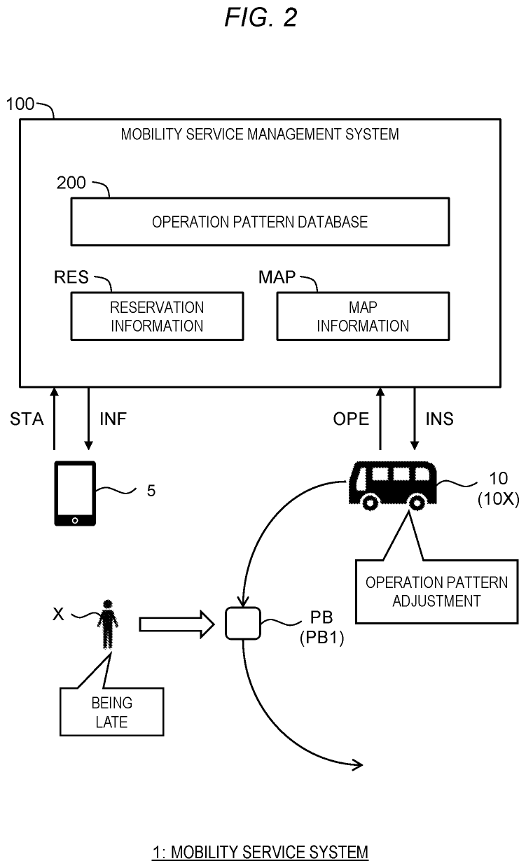

FIG. 2 is a conceptual diagram for explaining an outline of the operation pattern adjustment process according to the present embodiment.

The user terminal 5 periodically transmits “user status information STA” to the mobility service management system 100. The user status information STA indicates at least a position and a moving speed of the user X (i.e., the user terminal 5). For example, the position and the moving speed of the user X are acquired by utilizing a GPS (Global Positioning System) function installed on the user terminal 5. The user status information STA may include a travel route to the first pick-up point PB1. The user status information STA may include a transportation used to the first pick-up point PB1. The user status information STA is transmitted at least until the user X arrives at the first pick-up point PB1.

The mobility service management system 100 periodically receives the user status information STA from the user terminal 5. Then, based on the user status information STA, the mobility service management system 100 predicts a time at which the user X arrives at the first pick-up point PB1. The time at which the user X is expected to arrive at the first pick-up point PB1 is hereinafter referred to as a “first expected arrival time tx1.” For example, the mobility service management system 100 calculates the first expected arrival time tx1 based on the user status information STA and map information MAP. When the user X is traveling by the use of a public transportation, the mobility service management system 100 may calculate the first expected arrival time tx1 by referring to an operation schedule and an operation status of the public transportation as well.

When the first expected arrival time tx1 is later than the reservation time tx0, the mobility service management system 100 executes the “operation pattern adjustment process” that adjusts the operation pattern of the assigned vehicle 10X based on the operation pattern database 200.

Typically, adjusting the operation pattern of the assigned vehicle 10X includes changing the target arrival time at which the assigned vehicle 10X arrives at the first pick-up point PB1. For example, the target arrival time can be changed by changing at least one of the travel route and the travel pattern of the assigned vehicle 10X. Alternatively, the target arrival time can be changed also by changing the assigned vehicle 10X assigned to user X.

Adjusting the operation pattern of the assigned vehicle 10X may include changing the pick-up point PB for picking up user X from the original first pick-up point PB1 to another second pick-up point PB2. The assigned vehicle 10X assigned to user X may remain the same as that in a reservation stage or may be changed.

A “target pick-up point PBt” is an ultimately determined pick-up point PB. The target pick-up point PBt may be the original first pick-up point PB1 indicated by the reservation information RES, or may be the second pick-up point PB2 specified as a result of the operation pattern adjustment process.

A “waiting time” is a time from when the assigned vehicle 10X arrives at the target pick-up point PBt for picking up the user X to when the user X arrives at the target pick-up point PBt. The mobility service management system 100 executes the operation pattern adjustment process such that the waiting time is reduced as compared with a case where the operation pattern adjustment process is not executed. Since the waiting time of the assigned vehicle 10X at the target pick-up point PBt is reduced, the influence of the assigned vehicle 10X on the surrounding traffic flow is suppressed.

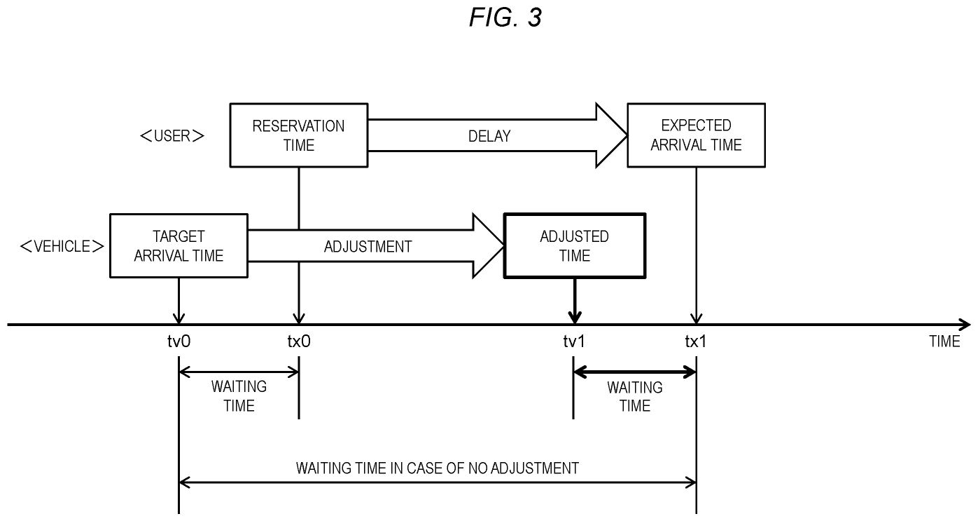

FIG. 3 is a conceptual diagram for explaining an example of the operation pattern adjustment process. A time tv0, which is the target arrival time at which the assigned vehicle 10X arrives at the first pick-up point PB1, is the original target arrival time before the operation pattern is adjusted. The target arrival time tv0 is set to be immediately before the reservation time tx0. For example, the target arrival time tv0 is set such that a time from the target arrival time tv0 to the reservation time tx0 is equal to or shorter than a threshold (e.g., about a few tens of seconds to 1 minute).

The first expected arrival time tx1 is the time at which the user X is expected to arrive at the first pick-up point PB1. When the first expected arrival time tx1 is later than the reservation time tx0, the waiting time (i.e., from tv0 to tx1) becomes long. Therefore, the mobility service management system 100 performs the operation pattern adjustment process such that the waiting time is reduced.

More specifically, a “first adjusted time tv1” is a time between the reservation time tx0 and the first expected arrival time tx1. For example, a time from the first adjusted time tv1 to the first expected arrival time tx1 is equal to or shorter than a threshold (e.g., about a few tens of seconds to 1 minute). The mobility service management system 100 adjusts the operation pattern of the assigned vehicle 10X such that the assigned vehicle 10X arrives at the first pick-up point PB1 at the first adjusted time tv1. As a result, the waiting time becomes a time from the first adjusted time tv1 to the first expected arrival time tx1 and is reduced as compared with the waiting time (from tv0 to tx1) before the operation pattern adjustment.

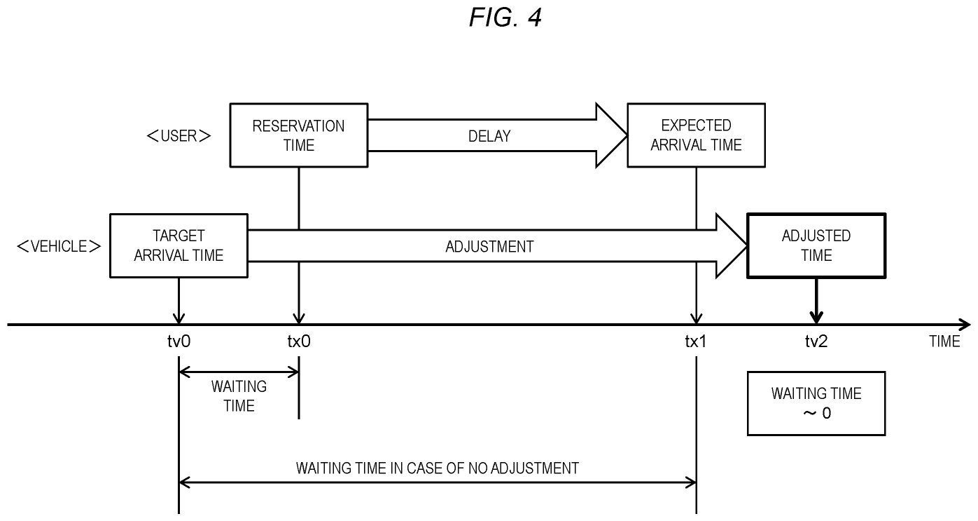

FIG. 4 is a conceptual diagram for explaining another example of the operation pattern adjustment process. A “second adjusted time tv2” is a time later than the first expected arrival time tx1. When the user X approves picking-up at the second adjusted time tv2, the mobility service management system 100 adjusts the operation pattern of the assigned vehicle 10X such that the assigned vehicle 10X arrives at the first pick-up point PB1 at the second adjusted time tv2. As a result, the waiting time becomes nearly zero and is reduced as compared with the waiting time (from tv0 to tx1) before the operation pattern adjustment. Even though the user X may need to wait a little, the user X is still able to utilize the mobility service.

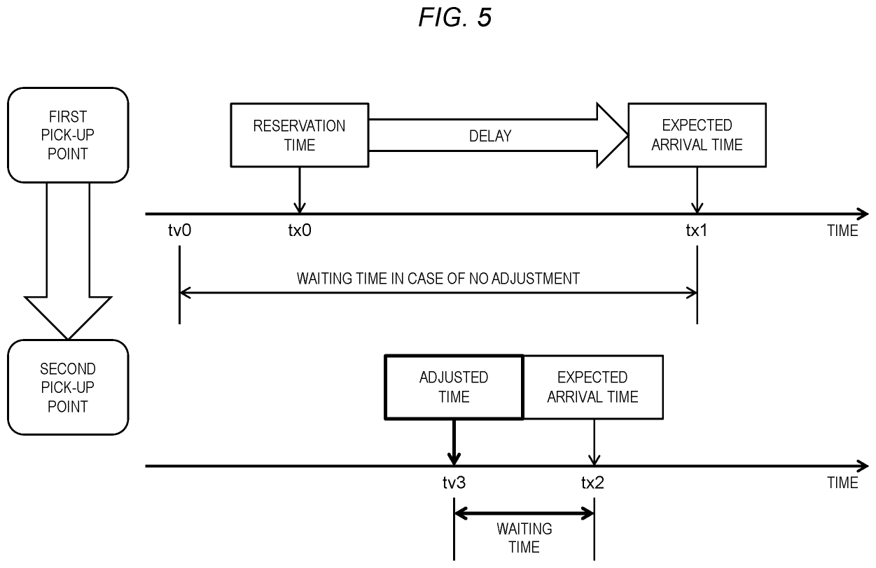

FIG. 5 is a conceptual diagram for explaining yet another example of the operation pattern adjustment process. In the example shown in FIG. 5, the target pick-up point PBt for picking up the user X is changed from the original first pick-up point PB1 to another second pick-up point PB2. For example, when the user X is moving on a train and the first pick-up point PB1 is located in front of a first station, the second pick-up point PB2 is located in front of a second station in front of the first station.

A “second expected arrival time tx2” is a time at which the user X is expected to arrive at the second pick-up point PB2. A “third adjusted time tv3” is a time before the second expected arrival time tx2. For example, a time from the third adjusted time tv3 to the second expected arrival time tx2 is equal to or shorter than a threshold (e.g., about a few tens of seconds to 1 minute). The third adjusted time tv3 is set such that the waiting time from the third adjusted time tv3 to the second expected arrival time tx2 becomes shorter than at least the waiting time (from tv0 to tx1) in the case where the target pick-up point PBt remains the first pick-up point PB1.

When the user X approves picking-up at the second pick-up point PB2, the mobility service management system 100 changes the target pick-up point PBt for picking up the user X to the second pick-up point PB2. Further, the mobility service management system 100 adjusts the operation pattern of the assigned vehicle 10X such that the assigned vehicle 10X arrives at the second pick-up point PB2 at the third adjusted time tv3. As a result, the waiting time becomes a time from the third adjusted time tv3 to the second expected arrival time tx2, and is reduced as compared with the waiting time (from tv0 to tx1) before the operation pattern adjustment.

It should be noted that in any of the examples shown in FIGS. 3 to 5, the assigned vehicle 10X may remain the same as that in a reservation stage or may be changed. That is, the assigned vehicle 10X may be a first vehicle assigned to the user X in the reservation stage, or may be a second vehicle assigned to the user X as a substitute for the first vehicle in the operation pattern adjustment process.

### Effects

As described above, according to the present embodiment, the first expected arrival time tx1 at which the user X arrives at the first pick-up point PB1 is calculated based on the user status information STA. When the first expected arrival time tx1 is later than the reservation time tx0, the operation pattern adjustment process is executed. The operation pattern adjustment process is executed such that the waiting time is reduced as compared with the case where the operation pattern adjustment process is not executed. Since the waiting time is reduced, the influence of the assigned vehicle 10X that picks up the user X on the surrounding traffic flow is suppressed. This is especially preferable in urban areas being tight on land and having a large traffic volume.

From a viewpoint of the user X, it is possible to avoid a situation where the mobility service is completely unavailable merely due to a slight lateness. Since the mobility service is flexible to some extent, satisfaction with the mobility service is increased.

From a viewpoint of a service provider, loss of service opportunities is suppressed.

Hereinafter, the vehicle 10 and the mobility service management system 100 according to the present embodiment will be described in more detail.

### 3. CONFIGURATION EXAMPLE OF VEHICLE

### 3-1. Configuration Example

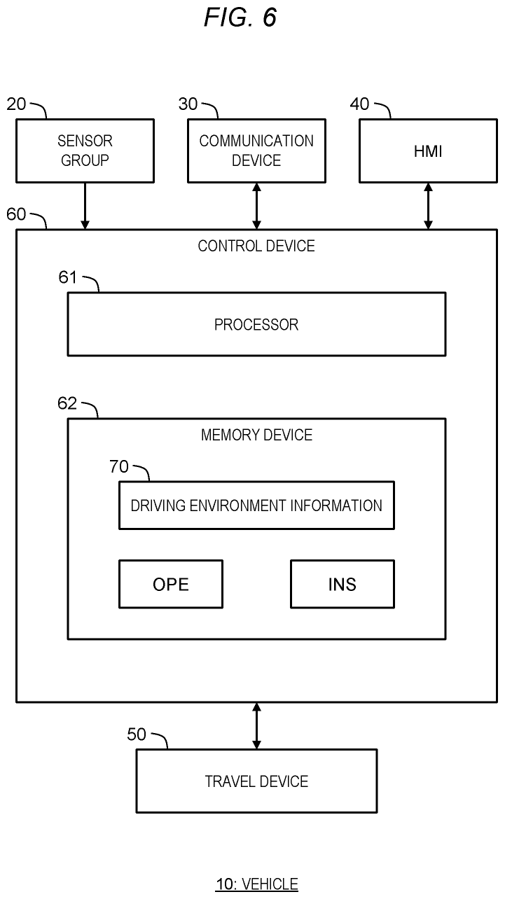

FIG. 6 is a block diagram showing a configuration example of the vehicle 10 according to the present embodiment. The vehicle 10 includes a sensor group 20, a communication device 30, a travel device 50, and a control device 60. The vehicle 10 driven by the driver may further include an HMI (Human Machine Interface) 40.

The sensor group 20 includes a vehicle state sensor that detects a state of the vehicle 10. The vehicle state sensor includes a speed sensor, an acceleration sensor, a yaw rate sensor, a steering angle sensor, and the like. The sensor group 20 also includes a position sensor that detects a position and an orientation of the vehicle 10. The position sensor is exemplified by a GPS (Global Positioning System) sensor. Moreover, the sensor group 20 includes a recognition sensor that recognizes (detects) a situation around the vehicle 10. Examples of the recognition sensor include a camera, a LIDAR(Laser Imaging Detection and Ranging), a radar, and the like.

The communication device 30 communicates with the outside of the vehicle 10. For example, the communication device 30 communicates with the mobility service management system 100.

The HMI 40 is an user interface for delivering information to the driver and for receiving information from the driver. Examples of the HMI 40 include a display, a touch panel, a head-up display, and the like.

The travel device 50 includes a steering device, a driving device, and a braking device. The steering device turns wheels. For example, the steering device includes an electric power steering (EPS) device. The driving device is a power source that generates a driving force. Examples of the drive device include an engine, an electric motor, an in-wheel motor, and the like. The braking device generates a braking force.

The control device (controller) 60 controls the vehicle 10. The control device 60 includes one or more processors 61 (hereinafter simply referred to as a processor 61) and one or more memory devices 62 (hereinafter simply referred to as a memory device 62). The processor 61 executes a variety of processing. For example, the processor 61 includes a CPU (Central Processing Unit). The memory device 62 stores a variety of information. Examples of the memory device 62 include a volatile memory, a non-volatile memory, an HDD (Hard Disk Drive), an SSD (Solid State Drive), and the like. The variety of processing by the processor 61 (the control device 60) is implemented by the processor 61 executing a control program being a computer program. The control program is stored in the memory device 62 or recorded on a non-transitory computer-readable readable recording medium. The control device 60 may include one or more ECUs (Electronic Control Units).

### 3-2. Driving Environment Information

The control device 60 (the processor 61) uses the sensor group 20 to acquire driving environment information 70 indicating a driving environment for the vehicle 10. The driving environment information 70 includes vehicle state information, vehicle position information, and surrounding situation information. The vehicle state information indicates a vehicle state (e.g., the vehicle speed, etc.) detected by the vehicle state sensor. The vehicle position information indicates the position and the orientation of the vehicle 10 detected by the position sensor. The surrounding situation information indicates a result of recognition by the recognition sensor. For example, the surrounding situation information includes an image captured by the camera. The surrounding situation information may include object information regarding an object around the vehicle 10. Examples of the object around the vehicle 10 include a pedestrian, another vehicle (e.g., a preceding vehicle, a parked vehicle, etc.), a sign, a white line, a roadside structure, and the like. The object information indicates a relative position and a relative velocity of the object with respect to the vehicle 10. The driving environment information 70 is stored in the memory device 62.

### 3-3. Communication Process

The control device 60 (the processor 61) communicates with the mobility service management system 100 through the communication device 30.

For example, the processor 61 transmits the operation status information OPE to the mobility service management system 100 through the communication device 30. The operation status information OPE indicates the operation status of the vehicle 10. The operation status information OPE includes a part of the driving environment information 70 described above. For example, the operation status information OPE indicates the current position of the vehicle 10. In addition, the operation status information OPE may indicate the vehicle speed of the vehicle 10. Furthermore, the operation status information OPE includes an expected arrival time at which the vehicle 10 arrives at the pick-up point PB. The expected arrival time is calculated, for example, based on the current position, the vehicle speed, and the pick-up point PB. In calculating the expected arrival time, traffic jam information provided from a traffic information center may be taken into consideration.

Moreover, the processor 61 receives the operation pattern instruction INS from the mobility service management system 100 through the communication device 30. The operation pattern instruction INS indicates the operation pattern that the vehicle 10 must follow.

### 3-4. Information Delivery Process

The control device 60 (the processor 61) delivers necessary information to the driver through the HMI 40. For example, the processor 61 presents the operation pattern indicated by the operation pattern instruction INS to the driver. For example, the processor 61 displays the operation pattern on the display.

### 3-5. Vehicle Travel Control

The control device 60 (the processor 61) executes vehicle travel control that controls travel of the vehicle 10. The vehicle travel control includes steering control, acceleration control, and deceleration control. The processor 61 executes the vehicle travel control by controlling the travel device 50 (the steering device, the driving device, and the braking device).

The processor 61 may execute automated driving control. In this case, the processor 61 executes the vehicle travel control such that the vehicle 10 automatically travels in accordance with the operation pattern indicated by the operation pattern instruction INS. The processor 61 generates a target trajectory of the vehicle 10 based on the operation pattern and the above-described driving environment information 70. The target trajectory includes a target position and a target velocity. Then, the processor 61 executes the vehicle travel control such that the vehicle 10 follows the target trajectory.

In the case of manual driving, the processor 61 executes the vehicle travel control in accordance with a driving operation performed by the driver.

### 4. MOBILITY SERVICE MANAGEMENT SYSTEM

### 4-1. Configuration Example

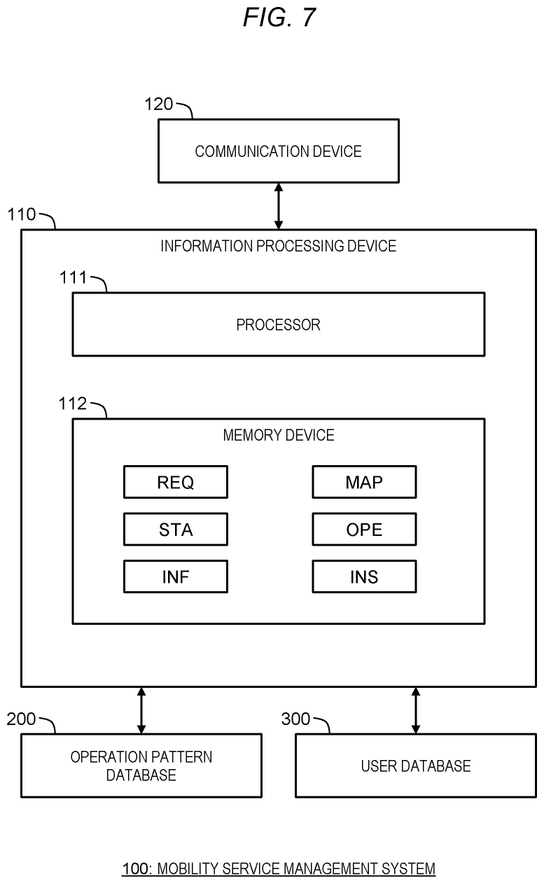

FIG. 7 is a block diagram showing a configuration example of the mobility service management system 100 according to the present embodiment. The mobility service management system 100 includes an information processing device 110, a communication device 120, an operation pattern database 200, and a user database 300.

The information processing device 110 executes a variety of information processing. The information processing device 110 includes one or more processors 111 (hereinafter simply referred to as a processor 111) and one or more memory devices 112 (hereinafter simply referred to as a memory device 112). The processor 111 executes a variety of information processing. For example, the processor 111 includes a CPU. The memory device 112 stores a variety of information. Examples of the memory device 112 include a volatile memory, a non-volatile memory, an HDD, an SSD, and the like. Functions of the information processing device 110 are achieved by the processor 111 executing a mobility service management program being a computer program. The mobility service management program is stored in the memory device 112. The mobility service management program may be recorded on a non-transitory computer-readable recording medium. The mobility service management program may be provided via a network.

The communication device 120 communicates with the outside. For example, the communication device 120 communicates with the vehicle 10. In addition, the communication device 120 communicates with the user terminal 5.

The operation pattern database 200 indicates the operation pattern of each of the vehicles 10 used in the mobility service. The operation pattern database 200 is implemented by a storage device that is accessible by the information processing device 110. The processor 111 manages the operation pattern database 200.

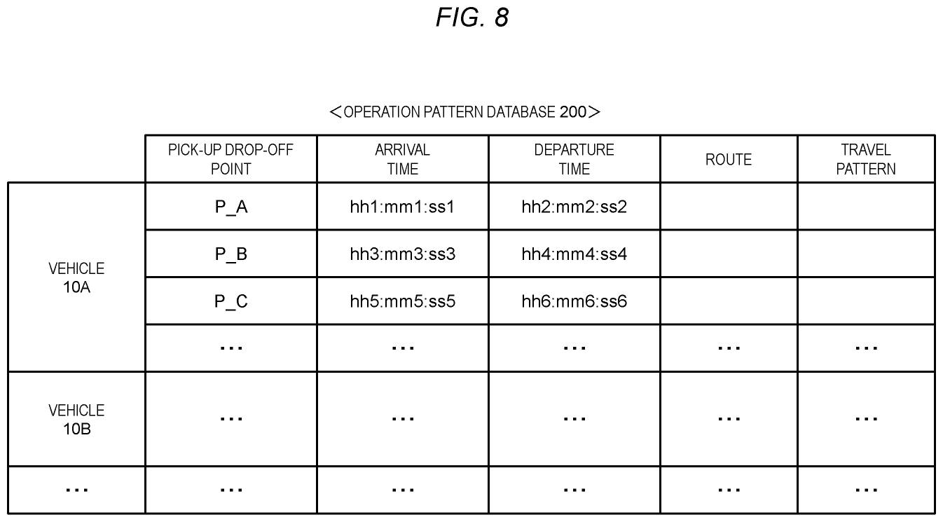

FIG. 8 is a conceptual diagram showing an example of the operation pattern database 200. In the example showing in FIG. 8, the operation pattern database 200 indicates a pick-up drop-off point, a target arrival time, a target departure time, a travel route, and a travel pattern for each vehicle 10. The travel pattern includes a target vehicle speed and the like.

The user database 300 indicates user information on each user of the mobility service. The user information includes user registration information, terminal information of the user terminal 5, reservation information, and the like.

The mobility service management system 100 is implemented, for example, by a management server. A plurality of management servers may perform distributed processing.

### 4-2. Reservation Acceptance Process

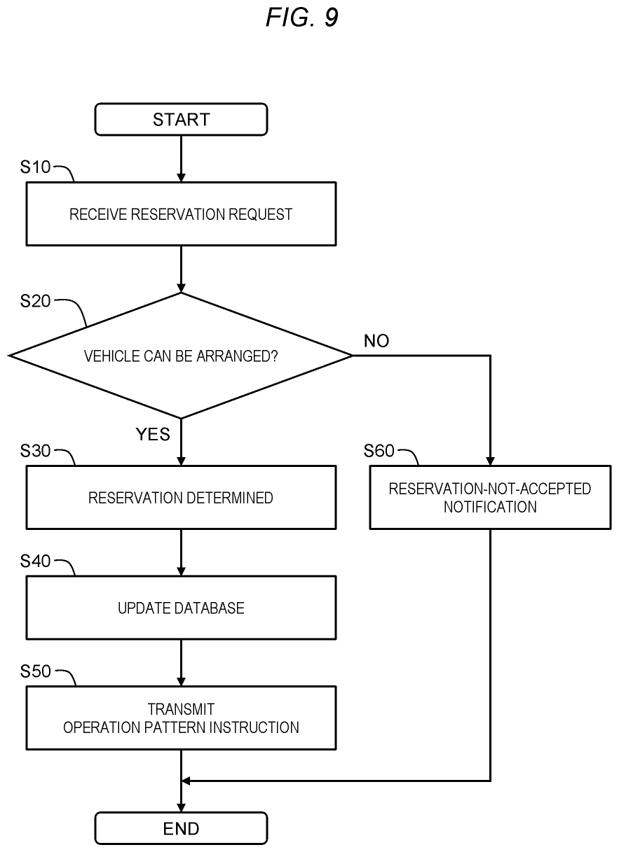

FIG. 9 is a flow chart showing a reservation acceptance process according to the present embodiment.

In Step S10, the processor 111 receives the reservation request REQ from the user terminal 5 through the communication device 120. The reservation request REQ includes at least the pick-up point PB and the pick-up time that are specified by the user X. The reservation request REQ may include a drop-off point (destination) specified by user X.

In Step S20, the processor 111 searches for a vehicle 10 that is able to deliver the mobility service to the user X based on the reservation request REQ. That is, the processor 111 searches for a vehicle 10 that is able to meet the user X's requirement indicated by the reservation request REQ. The operation pattern of each vehicle 10 is obtained from the operation pattern database 200. Therefore, the processor 111 is able to search for a vehicle 10 that can meet the user X's requirement by referring to the operation pattern database 200. The processor 111 may assign a new vehicle 10 whose operation pattern is not yet set to the user X.

When it is possible to arrange the vehicle 10 (the assigned vehicle 10X) that can meet the user X's requirement (Step S20; Yes), the processing proceeds to Step S30. Otherwise (Step S20; No), the processing proceeds to Step S60.

In Step S30, the processor 111 communicates with the user terminal 5 through the communication device 120 and transmits information of the mobility service that can be reserved to the user terminal 5. The user terminal 5 presents the information of the mobility service that can be reserved to the user X. The user X operates the user terminal 5 to determine the reservation. When the reservation is determined, the processor 111 acquires the reservation information RES indicating the determined reservation. The reservation information RES indicates the reservation that “the assigned vehicle 10X picks up the user X at the first pick-up point PB1 at the reservation time tx0.” The processor 111 may transmit the reservation information RES to the user terminal 5 through the communication device 120.

In Step S40, the processor 111 generates or updates the operation pattern of the assigned vehicle 10X. For example, the processor 111 generates or updates the operation pattern of the assigned vehicle 10X such that the assigned vehicle 10X arrives at the first pick-up point PB 1 immediately before the reservation time tx0. Then, the processor 111 updates the operation pattern database 200 by reflecting the latest operation pattern of the assigned vehicle 10X in the operation pattern database 200.

In Step S50, the processor 111 transmits the operation pattern instruction INS to the assigned vehicle 10X through the communication device 120. The operation pattern instruction INS includes the operation pattern of the assigned vehicle 10X and instructs the assigned vehicle 10X to run in accordance with the operation pattern.

On the other hand, in Step S60, the processor 111 transmits a reservation-not-accepted notification to the user terminal 5 through the communication device 120. The user X receiving the reservation-not-accepted notification is able to rethink at least one of the pick-up point PB and the pick-up time.

### 4-3. Operation Pattern Adjustment Process

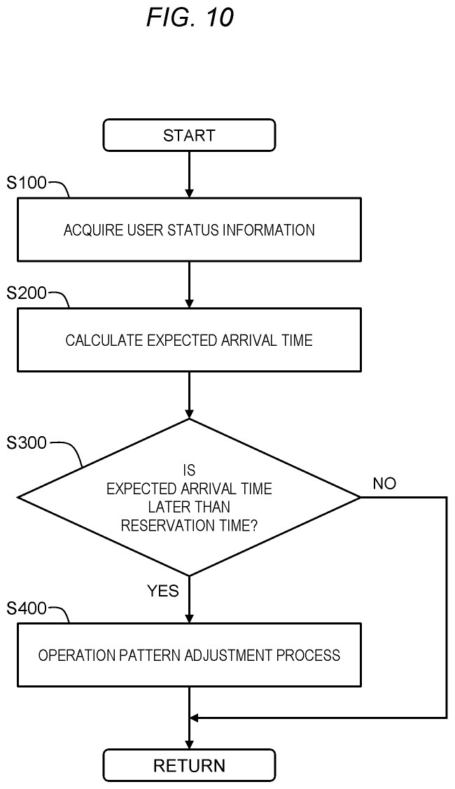

After the reservation acceptance process described above is executed and the reservation information RES is acquired, the operation pattern adjustment process is executed as necessary. FIG. 10 is a flow chart showing processing related to the operation pattern adjustment process according to an embodiment of the present disclosure. The process flow shown in FIG. 10 is performed repeatedly at a regular cycle.

In Step 5100, the processor 111 acquires the user status information STAs. The user status information STA indicates at least the position and the moving speed of the user X (i.e., the user terminal 5). For example, the position and the moving speed of the user X are acquired by utilizing the GPS function installed on the user terminal 5. The processor 111 can periodically receive the user status information STA from the user terminal 5 through the communication device 120.

The user status information STA may include a travel route to the first pick-up point PB1. The user status information STA may include a transportation used to the first pick-up point PB1. For example, the travel route and the transportation are input by the user X. Alternatively, the processor 111 may estimate the travel route and the transportation based on the position and the moving speed of the user X.

In Step 5200, the processor 111 calculates, based on the user status information STA, the first expected arrival time tx1 at which the user X arrives at the first pick-up point PB1. For example, the processor 111 calculates the first expected arrival time tx1 based on the user status information STA and the map information MAP. When the user X is moving by the use of a public transportation, the processor 111 may calculate the first expected arrival time tx1 by referring to an operation schedule and an operation status of the public transportation as well.

In Step 5300, the processor 111 determines whether or not the first expected arrival time tx1 is later than the reservation time tx0 indicated by the reservation information RES. When the first expected arrival time tx1 is later than the reservation time tx0 (Step 5300; Yes), the processing proceeds to Step 5400. Otherwise (Step S300; No), the processing in the current cycle ends.

In Step 5400, the processor 111 adjusts the operation pattern of the assigned vehicle 10X that picks up the user X (see FIGS. 3 to 5). The operation pattern of each vehicle 10 is acquired from the operation pattern database 200 described above. The processor 111 executes the operation pattern adjustment process based on the operation pattern database 200. In particular, the processor 111 executes the operation pattern adjustment process such that the waiting time of the assigned vehicle 10X at the target pick-up point PBt is reduced as compared with the case where the operation pattern adjustment process is not executed. Various examples of the operation pattern adjustment process (Step 5400) will be described below.

### 4-3-1. First Example

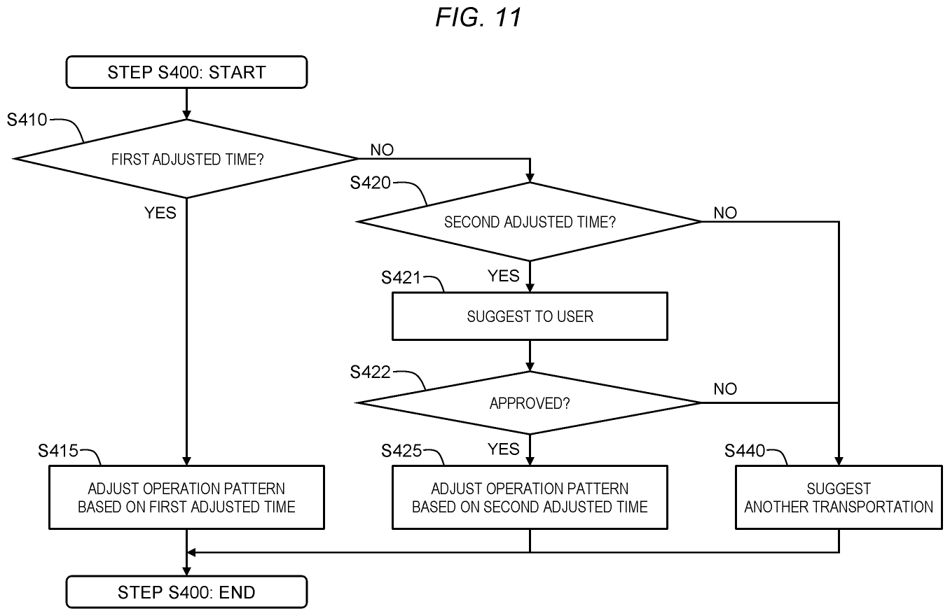

FIG. 11 is a flow chart showing a first example of the operation pattern adjustment process (Step S400). The first example corresponds to the examples shown in FIGS. 3 and 4 described above. In the first example, the processor 111 maintains the first pick-up point PB1 as the target pick-up point PBt for picking up the user X.

In Step 5410, the processor 111 determines whether or not the operation pattern of the assigned vehicle 10X is adjustable such that the assigned vehicle 10X arrives at the first pick-up point PB1 at a first adjusted time tv1. The first adjusted time tv1 is a time between the reservation time tx0 and the first expected arrival time tx1 (see FIG. 3). For example, a time from the first adjusted time tv1 to the first expected arrival time tx1 is equal to or shorter than a threshold (e.g., about a few tens of seconds to 1 minute).

If the assigned vehicle 10X has a tight schedule afterward, it may not possible to adjust the operation pattern of the assigned vehicle 10X. It is not always necessary to maintain the assigned vehicle 10X at the vehicle 10 (the first vehicle) assigned to the user X in the reservation stage. The processor 111 may change the assigned vehicle 10X to another vehicle 10 (the second vehicle). That is, the processor 111 may newly assign a second vehicle to the user X instead of the first vehicle.

When the operation pattern of the assigned vehicle 10X is adjustable such that the assigned vehicle 10X arrives at the first pick-up point PB1 at the first adjusted time tv1 (Step 5410; Yes), the processing proceeds to Step 5415. Otherwise (Step 5410; No), the processing proceeds to Step 5420.

In Step 5415, the processor 111 adjusts (updates) the operation pattern of the assigned vehicle 10X such that the assigned vehicle 10X arrives at the first pick-up point PB1 at the first adjusted time tv1. Then, the processor 111 updates the operation pattern database 200 by reflecting the latest operation pattern of the assigned vehicle 10X in the operation pattern database 200. Furthermore, the processor 111 transmits the latest operation pattern instruction INS to the assigned vehicle 10X through the communication device 120.

In addition, in Step 5415, the processor 111 may transmit the service information INF to the user terminal 5 through the communication device 120. The service information INF at this time notifies the change in the vehicle arrival time. For example, the service information INF notifies the first adjusted time tv1.

In Step 5420, the processor 111 determines whether or not the operation pattern of the assigned vehicle 10X is adjustable such that the assigned vehicle 10X arrives at the first pick-up point PB1 at a second adjusted time tv2. The second adjusted time tv2 is a time later than the first expected arrival time tx1 (see FIG. 4). As in the case of Step 5410 described above, the assigned vehicle 10X may remain the same as that in the reservation stage or may be changed.

When the operation pattern of the assigned vehicle 10X is adjustable such that the assigned vehicle 10X arrives at the first pick-up point PB1 at the second adjusted time tv2 (Step 5420; Yes), the processing proceeds to Step 5421. Otherwise (Step S420; No), the processing proceeds to Step 5440.

In Step 5421, the processor 111 transmits the service information INF to the user terminal 5 through the communication device 120. The service information INF at this time suggests picking-up at the second adjusted time tv2 to the user X. For example, the service information INF includes a message such as “It is available if your wait for two minutes. Would you like to use it?”

The user terminal 5 displays the service information INF received from the mobility service management system 100 on a display. The user X operates the user terminal 5 to approve or reject the suggestion. A response by the user X is transmitted from the user terminal 5 to the mobility service management system 100.

When the user X approves the suggestion (Step 5422; Yes), the processing proceeds to Step 5425. On the other hand, when the user X rejects the suggestion (Step S422; No), the processing proceeds to Step 5440.

In Step S425, the processor 111 adjusts (updates) the operation pattern of the assigned vehicle 10X such that the assigned vehicle 10X arrives at the first pick-up point PB1 at the second adjusted time tv2. Then, the processor 111 updates the operation pattern database 200 by reflecting the latest operation pattern of the assigned vehicle 10X in the operation pattern database 200. Furthermore, the processor 111 transmits the latest operation pattern instruction INS to the assigned vehicle 10X through the communication device 120.

In addition, in Step S425, the processor 111 may transmit the service information INF to the user terminal 5 through the communication device 120. The service information INF at this time notifies the change in the vehicle arrival time. For example, the service information INF notifies the second adjusted time tv2.

In Step 5440, the processor 111 transmits the service information INF to the user terminal 5 through the communication device 120. The service information INF at this time notifies that the user X may fail to make it for the reservation time tx0. In addition, the service information INF may suggest another transportation.

### 4-3-2. Second Example

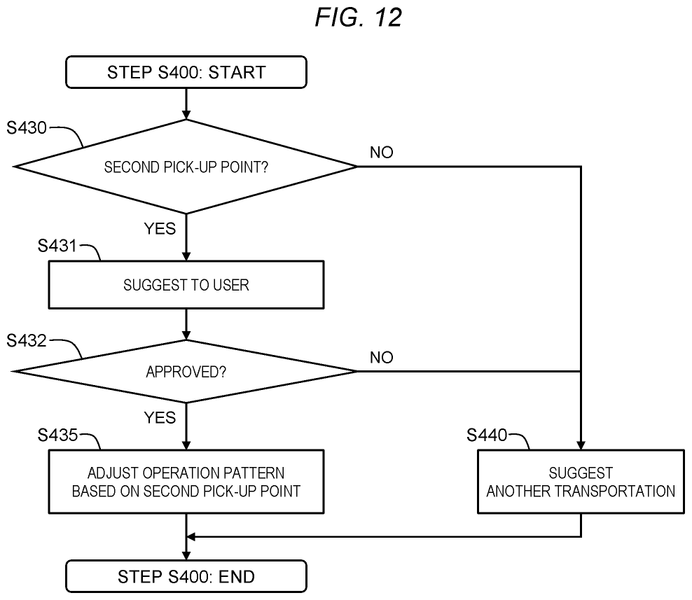

FIG. 12 is a flow chart showing a second example of the operation pattern adjustment process (Step S400). The second example corresponds to the example shown in FIG. 5 described above.

In Step S430, the processor 111 extracts a second pick-up point PB2 different from the first pick-up point PB1 based on the user status information STA and the map information MAP. For example, when the user X is moving on a train and the first pick-up point PB1 is located in front of a first station, the second pick-up point PB2 is located in front of a second station in front of the first station.

Moreover, the processor 111 calculates, based on the user status information STA, the second expected arrival time tx2 at which the user X arrives at the second pick-up point PB2. A method of calculating the second expected arrival time tx2 is the same as in the case of the first expected arrival time tx1.

Furthermore, the processor 111 determines whether or not the operation pattern of the assigned vehicle 10X is adjustable such that the assigned vehicle 10X arrives at the second pick-up point PB2 at a third adjusted time tv3. The third adjusted time tv3 is a time before the second expected arrival time tx2 (see FIG. 5). For example, a time from the third adjusted time tv3 to the second expected arrival time tx2 is equal to or shorter than a threshold (e.g., about a few tens of seconds to 1 minute). The third adjusted time tv3 is set such that the waiting time from the third adjusted time tv3 to the second expected arrival time tx2 becomes shorter than at least the waiting time (from tv0 to tx1) in the case where the target pick-up point PBt remains the first pick-up point PB1. It should be noted that as in the case of Step S410 described above, the assigned vehicle 10X may remain the same as that in the reservation stage or may be changed.

When the operation pattern of the assigned vehicle 10X is adjustable such that the assigned vehicle 10X arrives at the second pick-up point PB2 at the third adjusted time tv3 (Step 5430; Yes), the processing proceeds to Step 5431. Otherwise (Step S430; No), the processing proceeds to Step 5440.

In Step 5431, the processor 111 transmits the service information INF to the user terminal 5 through the communication device 120. The service information INF at this time suggests picking-up at the second pick-up point PB2 at the third adjusted time tv3 to the user X.

The user terminal 5 displays the service information INF received from the mobility service management system 100 on a display. The user X operates the user terminal 5 to approve or reject the suggestion. A response by the user X is transmitted from the user terminal 5 to the mobility service management system 100.

When the user X approves the suggestion (Step 5432; Yes), the processing proceeds to Step 5435. On the other hand, when the user X rejects the suggestion (Step S432; No), the processing proceeds to Step 5440.

In Step S435, the processor 111 changes the target pick-up point PBt for picking up the user X to the second pick-up point PB2. In addition, the processor 111 adjusts (updates) the operation pattern of the assigned vehicle 10X such that the assigned vehicle 10X arrives at the second pick-up point PB2 at the third adjusted time tv3. Then, the processor 111 updates the operation pattern database 200 by reflecting the latest operation pattern of the assigned vehicle 10X in the operation pattern database 200. Furthermore, the processor 111 transmits the latest operation pattern instruction INS to the assigned vehicle 10X through the communication device 120.

In addition, in Step S435, the processor 111 may transmit the service information INF to the user terminal 5 through the communication device 120. The service information INF at this time notifies the change in the pick-up point and the vehicle arrival time. For example, the service information INF notifies the second pick-up point PB2 and the third adjusted time tv3.

### 4-3-3. Third Example

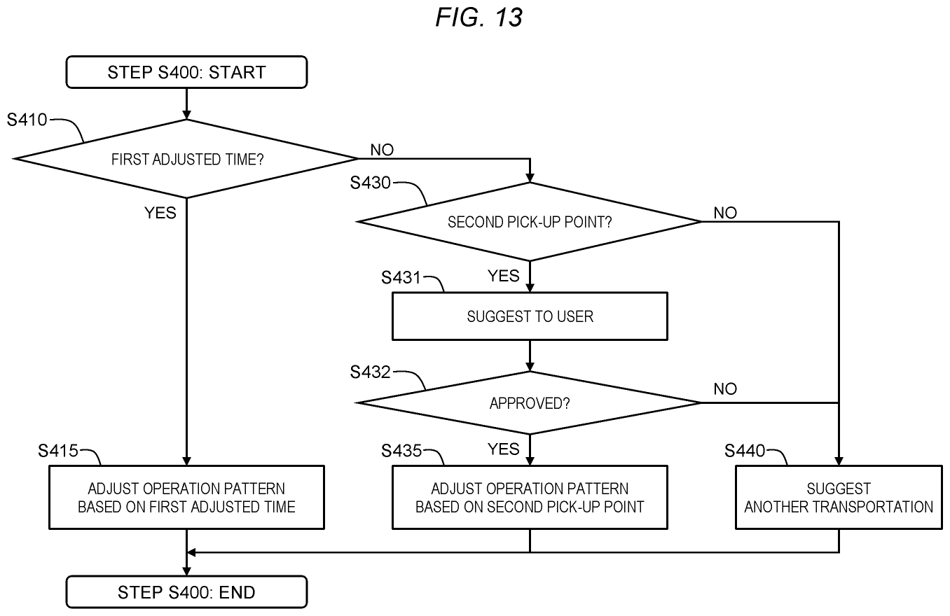

FIG. 13 is a flow chart showing a third example of the operation pattern adjustment process. The third example is a combination of the first example and the second example described above. Step S410 is the same as in the case of the first example. When the result of determination in Step S410 is negative (Step S410; No), the processing proceeds to Step S430. Processes after Step S430 are the same as in the case of the second example.

### 4-3-4. Fourth Example

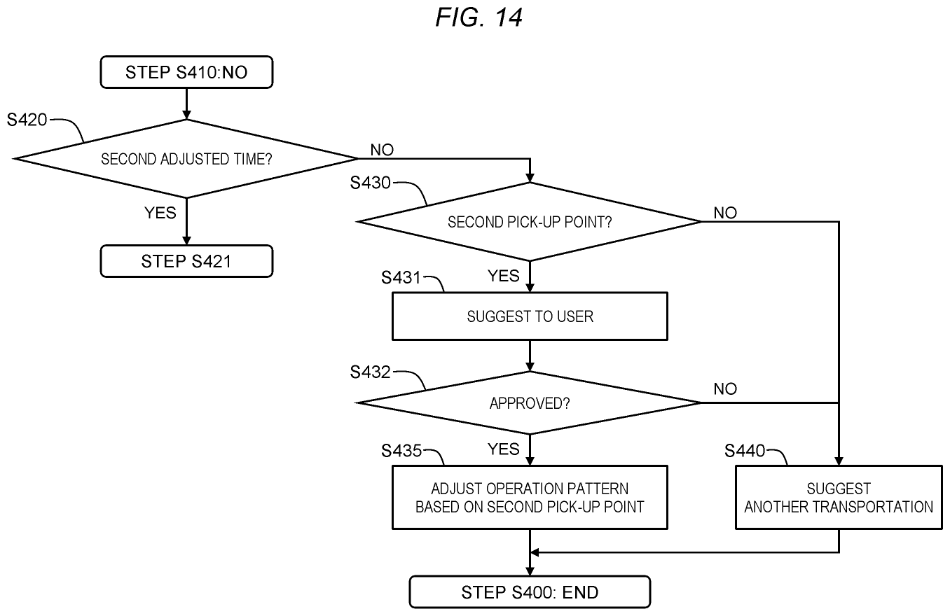

FIG. 14 is a flow chart showing a fourth example of the operation pattern adjustment process. The fourth example is a combination of the first example and the second example described above. Steps S410 and S420 are the same as in the case of the first example. When the result of determination in Step S420 is negative (Step S420; No), the processing proceeds to Step S430. Processes after Step S430 are the same as in the case of the second example.

### 4-3-5. Fifth Example

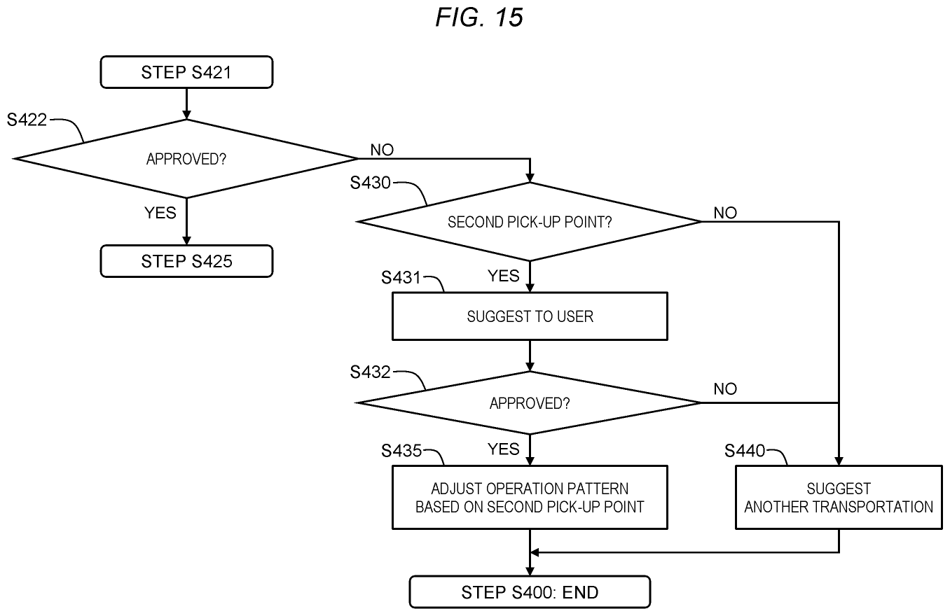

FIG. 15 is a flow chart showing a fifth example of the operation pattern adjustment process. The fifth example is a combination of the first example and the second example described above. Steps S410 to S422 are the same as in the case of the first example. When the user X rejects the suggestion in Step S422 (Step S422; No), the processing proceeds to Step S430. Processes after Step S430 are the same as in the case of the second example.

What is claimed is:

1. A mobility service system that delivers a mobility service utilizing a vehicle, the mobility service system comprising:
one or more processors; and
an operation pattern database indicating an operation pattern of the vehicle, wherein
the one or more processors are configured to:
acquire reservation information indicating a reservation that picks up a user of the mobility service at a first pick-up point at a reservation time;
acquire user status information indicating at least a position and a moving speed of the user;
calculate, based on the user status information, a first expected arrival time at which the user arrives at the first pick-up point; and
when the first expected arrival time is later than the reservation time, execute an operation pattern adjustment process that adjusts, based on the operation pattern database, the operation pattern of an assigned vehicle for picking up the user,
a waiting time is a time from when the assigned vehicle arrives at a target pick-up point for picking up the user to when the user arrives at the target pick-up point, and
the one or more processors are further configured to execute the operation pattern adjustment process such that the waiting time is reduced as compared with a case where the operation pattern adjustment process is not executed.

2. The mobility service system according to claim 1, wherein
in the operation pattern adjustment process, the one or more processors are further configured to:
determine whether or not the operation pattern of the assigned vehicle is adjustable such that the assigned vehicle arrives at the first pick-up point at a first adjusted time between the reservation time and the first expected arrival time; and
when the operation pattern of the assigned vehicle is adjustable such that the assigned vehicle arrives at the first pick-up point at the first adjusted time, adjust the operation pattern of the assigned vehicle such that the assigned vehicle arrives at the first pick-up point at the first adjusted time.

3. The mobility service system according to claim 2, wherein
a time from the first adjusted time to the first expected arrival time is equal to or shorter than a threshold.

4. The mobility service system according to claim 2, wherein
in the operation pattern adjustment process, the one or more processors are further configured to:
when the operation pattern of the assigned vehicle is not adjustable such that the assigned vehicle arrives at the first pick-up point at the first adjusted time, determine whether or not the operation pattern of the assigned vehicle is adjustable such that the assigned vehicle arrives at the first pick-up point at a second adjusted time later than the first expected arrival time; and
when the operation pattern of the assigned vehicle is adjustable such that the assigned vehicle arrives at the first pick-up point at the second adjusted time, suggest picking-up at the second adjusted time to the user.

5. The mobility service system according to claim 4, wherein
when the user approves the picking-up at the second adjusted time, the one or more processors are further configured to adjust the operation pattern of the assigned vehicle such that the assigned vehicle arrives at the first pick-up point at the second adjusted time.

6. The mobility service system according to claim 1, wherein
in the operation pattern adjustment process, the one or more processors are further configured to:
calculate, based on the user status information, a second expected arrival time at which the user arrives at a second pick-up point different from the first pick-up point;
determine whether or not the operation pattern of the assigned vehicle is adjustable such that the assigned vehicle arrives at the second pick-up point at a third adjusted time before the second expected arrival time; and
when the operation pattern of the assigned vehicle is adjustable such that the assigned vehicle arrives at the second pick-up point at the third adjusted time, suggest picking-up at the second pick-up point to the user.

7. The mobility service system according to claim 6, wherein
a time from the third adjusted time to the second expected arrival time is equal to or shorter than a threshold.

8. The mobility service system according to claim 6, wherein
a time from the third adjusted time to the second expected arrival time is shorter than the waiting time in a case where the target pick-up point remains the first pick-up point.

9. The mobility service system according to claim 6, wherein
when the user approves the picking-up at the second pick-up point, the one or more processors are further configured to change the target pick-up point to the second pick-up point and to adjust the operation pattern of the assigned vehicle such that the assigned vehicle arrives at the second pick-up point at the third adjusted time.

10. The mobility service system according to claim 1, wherein
the assigned vehicle is a first vehicle assigned to the user at a reservation stage or a second vehicle assigned to the user as a substitute for the first vehicle in the operation pattern adjustment process.

11. A mobility service delivery method that delivers a mobility service utilizing a vehicle, the mobility service delivery method comprising:
managing an operation pattern database indicating an operation pattern of the vehicle;
acquiring reservation information indicating a reservation that picks up a user of the mobility service at a first pick-up point at a reservation time;
acquiring user status information indicating at least a position and a moving speed of the user;
calculating, based on the user status information, a first expected arrival time at which the user arrives at the first pick-up point; and
when the first expected arrival time is later than the reservation time, executing an operation pattern adjustment process that adjusts, based on the operation pattern database, the operation pattern of an assigned vehicle for picking up the user, wherein
a waiting time is a time from when the assigned vehicle arrives at a target pick-up point for picking up the user to when the user arrives at the target pick-up point, and
the operation pattern adjustment process is executed such that the waiting time is reduced as compared with a case where the operation pattern adjustment process is not executed.
